(19) United States
(12) Patent Application Publication
(10) Pub. No.: US 2021/0337278 A1
(43) Pub. Date: Oct. 28, 2021

(54) PLAYBACK CONTROL METHOD AND APPARATUS, AND STORAGE MEDIUM

(71) Applicant: BAIDU ONLINE NETWORK TECHNOLOGY (BEIJING) CO., LTD., Beijing (CN)

(72) Inventor: Baicen HOU, Beijing (CN)

(73) Assignee: BAIDU ONLINE NETWORK TECHNOLOGY (BEIJING) CO., LTD.

(21) Appl. No.: 17/070,412

(22) Filed: Oct. 14, 2020

(30) Foreign Application Priority Data
Apr. 26, 2020 (CN) 202010341131.1

(51) Int. Cl. H04N 21/472; G11B 27/10

(52) U.S. Cl. CPC H04N 21/47217; G11B 27/10

(57) ABSTRACT

Embodiments of the present disclosure provide a playback control method. The method includes: obtaining a control instruction, wherein the control instruction comprises an identifier of a currently played video file, a current playback point, a control target, and a control type; dividing the video file corresponding to the identifier to playback units according to the control target, and obtaining at least one playback unit related to the control target in the video file; determining a playback unit to be controlled in the video file according to the control type and the at least one playback unit related to the control target; and performing a control process on the playback unit to be controlled.

### CROSS-REFERENCE TO RELATED APPLICATION

The present application is based upon and claims priority to Chinese Patent Application No. 202010341131.1, filed on Apr. 26, 2020, the entirety contents of which are incorporated herein by reference.

### TECHNICAL FIELD

The present disclosure relates to a field of multimedia technologies, especially a field of control processing technologies, and more particularly, to a playback control method, a playback control apparatus, and a non-transitory computer-readable storage medium.

### BACKGROUND

Currently, a video file may include a plurality of programs, for example, the video file of Spring Festival Gala includes programs such as songs, sketches, dances. When watching the video, if a user is not interested in a certain song and wants to watch the next program, the user needs to fast forward/play at multiple-fold speed, or drag a progress bar. When the progress bar reaches the next program, the video is played at a normal speed.

### SUMMARY

Embodiments of the present disclosure provide a playback control method, a playback control apparatus, and a non-transitory computer-readable storage medium.

Embodiments of the present disclosure provide a playback control method. The method includes: obtaining a control instruction, in which the control instruction includes an identifier of a currently played video file, a current playback point, a control target, and a control type; dividing the video file corresponding to the identifier to playback units according to the control target, and obtaining at least one playback unit related to the control target in the video file; determining a playback unit to be controlled in the video file according to the control type and the at least one playback unit related to the control target; and performing a control process on the playback unit to be controlled.

Embodiments of the present disclosure provide a playback control apparatus. The apparatus includes: a non-transitory computer-readable medium including computer-executable instructions stored thereon, and an instruction execution system which is configured by the instructions to implement at least one of: an obtaining module, configured to obtain a control instruction, in which the control instruction comprises an identifier of a currently played video file, a current playback point, a control target, and a control type; a dividing module, configured to divide the video file corresponding to the identifier to playback units according to the control target, and obtain at least one playback unit related to the control target in the video file; a determining module, configured to determine a playback unit to be controlled in the video file according to the control type and the at least one playback unit related to the control target; and a processing module, configured to perform a control process on the playback unit to be controlled.

Embodiments of the present disclosure provide a non-transitory computer-readable storage medium storing computer instructions, the computer instructions are used to cause the computer to implement a playback control method. The method includes: obtaining a control instruction, in which the control instruction includes an identifier of a currently played video file, a current playback point, a control target, and a control type; dividing the video file corresponding to the identifier to playback units according to the control target, and obtaining at least one playback unit related to the control target in the video file; determining a playback unit to be controlled in the video file according to the control type and the at least one playback unit related to the control target; and performing a control process on the playback unit to be controlled.

It should be understood that the content described in this section is not intended to identify key or important features of the embodiments of the present disclosure, nor is it intended to limit the scope of the present disclosure. Additional features of the present disclosure will be easily understood through the following description.

### BRIEF DESCRIPTION OF THE DRAWINGS

The accompanying drawings are used to better understand the solution, and do not constitute a limitation on the application, in which:

FIG. 1 is a schematic diagram of embodiment 1 of the present disclosure.

FIG. 2 is a schematic diagram of embodiment 2 of the present disclosure.

FIG. 3 is a schematic diagram of embodiment 3 of the present disclosure.

FIG. 4 is a schematic diagram of embodiment 4 of the present disclosure.

FIG. 5 is a schematic diagram of embodiment 5 of the present disclosure.

FIG. 6 is a block diagram of an electronic device used to implement the playback control method according to an embodiment of the present disclosure.

### DETAILED DESCRIPTION

The following describes the exemplary embodiments of the present disclosure with reference to the accompanying drawings, which includes various details of the embodiments of the present disclosure to facilitate understanding, which shall be considered merely exemplary. Therefore, those of ordinary skill in the art should recognize that various changes and modifications can be made to the embodiments described herein without departing from the scope and spirit of the present disclosure. For clarity and conciseness, descriptions of well-known functions and structures are omitted in the following description.

In the above method, it is difficult to quickly and accurately control playback of the video through fast forwarding/playing at multiple-fold speed, or dragging the progress bar, which requires manual adjustment by the user, thus the accuracy and efficiency are low, and the playback experience of the video file is poor.

A playback control method, a playback control apparatus, an electronic device, and a storage medium according to embodiments of the present disclosure are described below with reference to the accompany drawings.

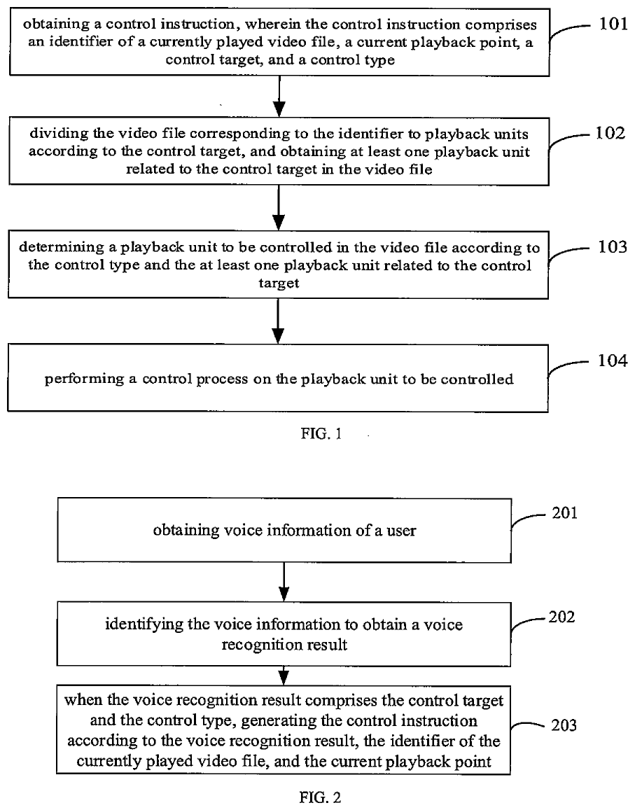

FIG. 1 is a schematic diagram of embodiment 1 of the present disclosure. It should be noted that an execution body of the playback control method in this embodiment is a playback control apparatus. In detail, the playback control apparatus may be a hardware device, or software in the hardware device. The hardware device may be a server.

As illustrated in FIG. 1, the playback control method is implemented as follows.

At step 101, a control instruction is obtained, in which the control instruction includes an identifier of a currently played video file, a current playback point, a control target, and a control type.

In the embodiment of the present disclosure, during the process of playing the video file, the playback control apparatus may obtain the control instruction through an instruction obtaining interface. The video file (also known as an audio-visual file) may include, but are not limited to, audiobooks, audio files, and video files. The control instruction may include the identifier of the currently played video file, the current playback point, the control target, and the control type. It should be noted that the identifier of the currently played video file is unique and is used to identify the currently played video file. The current playback point indicates a current playback location of the currently played video file. For example, the currently played video file is JJ Lin's concert, lyrics of “ [symbol] (which means that chrysanthemums are mangled on the ground)” from a Chinese song “Her love” is currently played, a playback location of the lyrics is at 10 minutes and 50 seconds in the video file, thus the current playback point is 10 minutes and 50 seconds. Since the video file may include, but are not limited to, audiobooks, audio files, and video files, in order to ensure better control of various types of video files, the control target may include any of a program, a first type of program, a program related to a first object, or a video clip. Programs may include various types of programs, for example, songs, dances, cross talks, and acrobatics. The first type of program may represent the same type of programs, for example, the first type program may be programs of song, or programs of dance. The program related to a first object may be a movie review program, or a historical character review program, and the video clip may be a movie segment, or a TV drama segment. The control type may include any one of loop playback, skipping, playing the next, favoring, and sharing.

It is understood that the control instruction is generated before the playback control apparatus obtains the control instruction. Optionally, in this embodiment of the present disclosure, voice information of a user is obtained and identified to obtain a voice recognition result, when the voice recognition result includes the control target and the control type, the control instruction is generated according to the voice recognition result, the identifier of the currently played video file, and the current playback point, reference may be made to a detailed description in subsequent embodiments.

At step 102, the video file corresponding to the identifier is divided into playback units according to the control target, and at least one playback unit related to the control target in the video file is obtained.

In the case of playing a plurality of video files simultaneously, the playback control apparatus more accurately divides the corresponding video files into playback units. In the embodiment of the present disclosure, the playback control apparatus may determine a corresponding video file according to the identifier of the currently played video file, divide the video file corresponding to the identifier into playback units according to the control target, and obtain at least one playback unit related to the control target in the video file.

For example, frame contents corresponding to the currently played video file are obtained. Feature information related to the control target in the frame contents of the video file. Relevance of adjacent frame contents in the video file is determined according to the feature information related to the control target in the frame contents, the video file is divided into the playback units according to the relevance, and the at least one playback unit related to the control target in the video file is obtained, reference may be made to a detailed description in subsequent embodiments.

At step 103, a playback unit to be controlled in the video file is determined according to the control type and the at least one playback unit related to the control target.

Optionally, when the control type is loop playback, favoring or sharing, the playback unit to be controlled is a playback unit related to the control target and comprising the current playback point; or, when the control type is playing the next, the playback unit to be controlled is the next playback unit of a playback unit related to the control target and comprising the current playback point.

That is, when the control type is loop playback, favoring or sharing, the playback unit related to the control target may include the playback unit of the current playback point, and the playback unit of the current play point related to the control target is determined as the playback unit to be controlled. When the control type is playing the next, the playback unit related to the control target may include the next playback unit of the playback unit of the current playback point, and the next playback unit of the playback unit of the current playback point related to the control target is determined as the playback unit to be controlled. Therefore, according to different control types, the playback unit to be controlled is determined more accurately.

For example, if the control type is loop playback, the control target is a program of a first type, such as a singing program, and a song program list is “Confession Balloon” (a Chinese song sang by JAY), “Come On” (an English song sang by Alex), and “Her Love” (a Chinese song sang by JJ Lin), then the at least one playback unit related to the control target include playback units of the above songs, and when the playback unit at the current playback point is “Her Love”, the playback unit of “Her Love” in the at least one playback unit related to the control target is determined as the playback unit to be controlled.

For another example, when the control type is playing the next, the control target is a first type of program, such as a sing program, the song program list is “Confession Balloon” (a Chinese song sang by JAY), “Come On” (an English song sang by Alex), and “Her Love” (a Chinese song sang by JJ Lin), then the at least one playback unit related to the control target include playback units of the above songs, and when the playback unit at the current playback point is “Confession Balloon”, the playback unit of “Come On” in the at least one playback unit related to the control target is determined as the playback unit to be controlled.

At step 104, a control process is performed on the playback unit to be controlled.

In the embodiment of the present disclosure, after determining the playback unit to be controlled, the playback control apparatus perform the control process on the playback unit to be controlled, for example, loop playback, skipping, favoring, and sharing. It should be noted that each playback unit in the video file is defined according to a start time point and an end time point of the playback unit. For example, loop playback means that when the song is played to the end time point, the song is played again from the start time point. When sharing a certain sketch comedy, the entire comedy show is shared from the start time point to the end time point. When favoring a dance, the entire dance is favored from the start time point to the end time point. Playing the next means to skip to the next playback unit to play (playback of the current playback unit ends, and the next playback unit is played at the start time point).

In conclusion, based on the control instruction, different playback units of the currently played video file are divided according to the control target, which automatically and accurately performs a control process on the different playback units in the video file, and effectively improves processing efficiency and playback experience of the video file.

FIG. 2 is a schematic diagram of embodiment 2 of the present disclosure. As illustrated in FIG. 2, the process of obtaining voice information of a user; identifying the voice information to obtain a voice recognition result; and when the voice recognition result includes the control target and the control type, generating the control instruction according to the voice recognition result, the identifier of the currently played video file, and the current playback point is implemented as follows.

At step 201, voice information of a user is obtained.

In the embodiment of the present disclosure, a voice input interface may be provided for the user, and the user may input the voice information through the voice input interface. For example, the voice input interface may be provided on a remote control to receive the voice input by the user and send the voice to the playback control apparatus, then the playback control apparatus obtains the voice information of the user.

At step 202, the voice information is identified to obtain a voice recognition result.

Next, the playback control apparatus may recognize the acquired voice information based on voice recognition algorithm to obtain the voice recognition result. The voice recognition algorithm may include, but is not limited to, an algorithm based on dynamic time warping, a hidden Markov model method based on parameter models, and a vector quantization method based on non-parametric models.

At step 203, when the voice recognition result includes the control target and the control type, the control instruction is generated according to the voice recognition result, the identifier of the currently played video file, and the current playback point.

As an example, after the voice recognition result is obtained, when the voice recognition result includes the control target and the control type, the playback control apparatus may generate the control instruction according to the voice recognition result, the identifier of the currently played video file, and the current playback point. It should be noted that when the control target is not included in the voice recognition result, the control target could be set. As an example, the control target is set according to the playback unit of the current playback point. For example, if the playback unit of the current playback point is a song program, the control target is set to the program of the first type.

For example, if the user inputs a voice information of “playing “Her Love” in a loop playback mode”, through voice recognition, the voice recognition result includes that the control target is the program of the first type (e.g., singing program), and the control type is loop playback, the playback control apparatus generates the control instruction according to the voice recognition result, the identifier of the currently played video file, and the current playback point. For another example, “Her Love” is currently being played, and the user inputs a voice information of “loop playback”, through voice recognition, the voice recognition result includes the control type of loop playback, and the recognition result does not include the control target. According to the playback unit of the current playback point, the control target is set to the program of the first type (for example, the singing program), the playback control apparatus generates the control instruction according to the voice recognition result, the identifier of the currently played video file, and the current playback point.

Thus, by acquiring the user voice information, the user voice information is identified, and when the user voice recognition result includes the control target and the control type, the control instruction is generated according to the voice recognition result, the identifier of the currently played video file, and the current playback point. Therefore, the user experience is better improved.

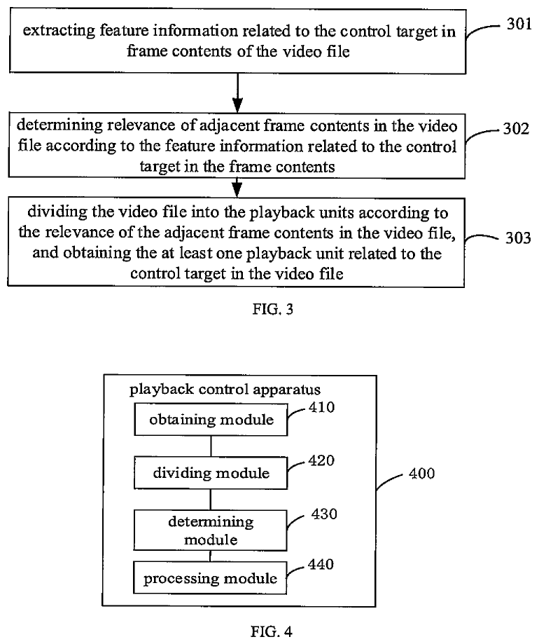

FIG. 3 is a schematic diagram of embodiment 3 of the present disclosure. As illustrated in FIG. 3, frame contents corresponding to the currently played video file is obtained, feature information related to the control target is extracted in the frame contents of the video file, and relevance of adjacent frame contents in the video file is determined according to the feature information related to the control target in the frame contents. The video file is divided into the playback units according to the relevance of the adjacent frame contents in the video file, and the at least one playback unit related to the control target is obtained in the video file.

At step 301, feature information related to the control target is extracted in the frame contents of the video file.

In the embodiment of the present disclosure, the playback control apparatus may extract the frame contents of the video file, and the feature information related to the control target in the frame contents is extracted based on feature extraction algorithm. For example, the control target is a program, and the program includes song programs, dance programs, and cross talk programs. The feature information related to song programs, dance programs, or cross talk programs is extracted in the frame contents of the video file respectively. For another example, if the control target is the program of the first type, and the program of the first type is a song program, the feature information related to the song in the frame contents of the video file is extracted.

At step 302, relevance of adjacent frame contents in the video file is determined according to the feature information related to the control target in the frame contents.

As an example, by comparing the feature information related to the control target in the frame contents, the relevance of adjacent frame contents in the video file is determined through relevance determination.

At step 303, the video file is divided into the playback units according to the relevance of the adjacent frame contents in the video file, and the at least one playback unit related to the control target in the video file is obtained.

It is understood that the relevance of adjacent frame contents in the same playback unit is high. The relevance of adjacent frame contents in different playback units is low. For example, basically, performers and performance background in the same playback unit are the same. The performers and performance background of different playback units have great difference. Therefore, the video file is divided into the playback units according to the relevance of the adjacent frame contents in the video file, and the at least one playback unit related to the control target is obtained.

Thus, the relevance of adjacent frame contents in the video file is determined by extracting the frame contents and the feature information related to the control target in the video file, and the video file is divided according to the relevance to obtain the at least one playback unit related to the control target in the video file. It is ensured that the video file is divided according to the contents of the playback units, and the control process is accurately performed on the playback units in the video file based on the divided playback units in the video file.

With the playback control method according to the embodiments of the present disclosure, the control instruction is obtained, in which the control instruction includes the identifier of the currently played video file, the current playback point, the control target, and the control type. The video file corresponding to the identifier is divided into the playback units according to the control target, and the at least one playback unit related to the control target in the video file is obtained. The playback unit to be controlled in the video file is determined according to the control type and the at least one playback unit related to the control target. The control process is performed on the playback unit to be controlled. This method is based on control instructions and divides the currently played video file into the playback units according to the control target, which automatically and accurately performs the control process on different playback units in the video file, and effectively improves the processing efficiency and playback experience of the video file.

In order to implement the foregoing embodiments, the embodiments of the present disclosure also provide a playback control apparatus.

FIG. 4 is a schematic diagram of embodiment 4 of the present disclosure. As illustrated in FIG. 4, the playback control apparatus 400 includes: an obtaining module 410, a dividing module 420, a determining module 430 and a processing module 440.

The obtaining module 410 is configured to obtain a control instruction, in which the control instruction includes an identifier of a currently played video file, a current playback point, a control target, and a control type. The dividing module 420 is configured to divide the video file corresponding to the identifier to playback units according to the control target, and obtain at least one playback unit related to the control target in the video file. The determining module 430 is configured to determine a playback unit to be controlled in the video file according to the control type and the at least one playback unit related to the control target. The processing module 440 is configured to perform a control process on the playback unit to be controlled.

As a possible implementation of the embodiments of the present disclosure, as illustrated in FIG. 5, on the basis FIG. 4, the playback control apparatus 400 further includes: an identifying module 450 and a generating module 460.

The obtaining module 410 is further configured to obtain voice information of a user. The identifying module 450 is configured to identify the voice information to obtain a voice recognition result. The generating module 460 is configured to, when the voice recognition result comprises the control target and the control type, generate the control instruction according to the voice recognition result, the identifier of the currently played video file, and the current playback point.

As a possible implementation of the embodiments of the present disclosure, the control target includes any one of a program, a first type of program, a program related to a first object, or a video clip.

As a possible implementation of the embodiments of the present disclosure, the dividing module 420 is configured to: extract feature information related to the control target in frame contents of the video file; determine relevance of adjacent frame contents in the video file according to the feature information related to the control target in the frame contents; and divide the video file into the playback units according to the relevance of the adjacent frame contents in the video file, and obtain the at least one playback unit related to the control target in the video file.

As a possible implementation of the embodiments of the present disclosure, the control type includes any one of loop playback, skipping, playing the next, favoring, and sharing.

As a possible implementation of the embodiments of the present disclosure, when the control type is loop playback, favoring or sharing, the playback unit to be controlled is a playback unit related to the control target and comprising the current playback point; or, when the control type is playing the next, the playback unit to be controlled is the next playback unit of a playback unit related to the control target and comprising the current playback point.

With the playback control apparatus according to the embodiments of the present disclosure, the control instruction is obtained, in which the control instruction includes the identifier of the currently played video file, the current playback point, the control target, and the control type. The video file corresponding to the identifier is divided into the playback units according to the control target, and the at least one playback unit related to the control target in the video file is obtained. The playback unit to be controlled in the video file is determined according to the control type and the at least one playback unit related to the control target. The control process is performed on the playback unit to be controlled. This apparatus is based on control instructions and divides the currently played video file into the playback units according to the control target, which automatically and accurately performs the control process on the different playback units in the video file, and effectively improves the processing efficiency and playback experience of the video file.

According to the embodiments of the present disclosure, the present disclosure also provides an electronic device and a readable storage medium.

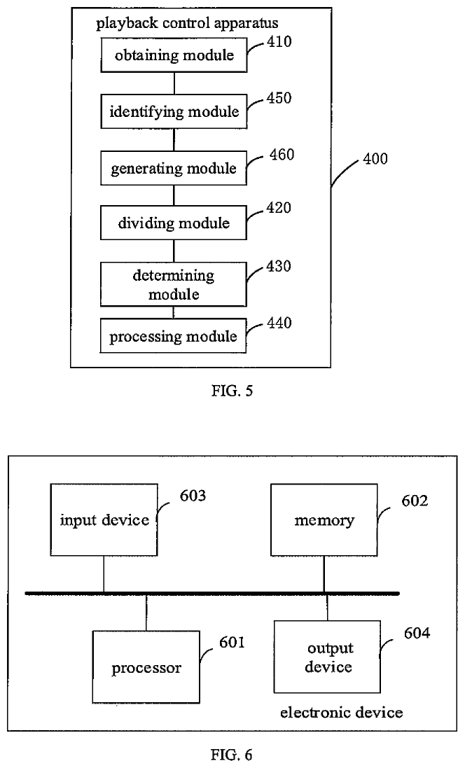

FIG. 6 is a block diagram of an electronic device used to implement the playback control method according to an embodiment of the present disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 6, the electronic device includes: one or more processors 601, a memory 602, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 601 is taken as an example in FIG. 6.

The memory 602 is a non-transitory computer-readable storage medium according to the present disclosure. The memory stores instructions executable by at least one processor, so that the at least one processor executes the playback control method according to the present disclosure. The non-transitory computer-readable storage medium of the present disclosure stores computer instructions, which are used to cause a computer to execute the playback control method according to the present disclosure.

As a non-transitory computer-readable storage medium, the memory 602 is configured to store non-transitory software programs, non-transitory computer executable programs and modules, such as program instructions/modules corresponding to the playback control method in the embodiment of the present disclosure (For example, the obtaining module 410, the dividing module 420, the determining module 430, and the processing module 440 shown in FIG. 4, the identifying module 450 and the generating module 460 shown in FIG. 5). The processor 601 executes various functional applications and data processing of the server by running non-transitory software programs, instructions, and modules stored in the memory 602, that is, implementing the playback control method in the foregoing method embodiment.

The memory 602 may include a storage program area and a storage data area, where the storage program area may store an operating system and application programs required for at least one function. The storage data area may store data created according to the use of the electronic device, and the like. In addition, the memory 602 may include a high-speed random access memory, and a non-transitory memory, such as at least one magnetic disk storage device, a flash memory device, or other non-transitory solid-state storage device. In some embodiments, the memory 602 may optionally include a memory remotely disposed with respect to the processor 601, and these remote memories may be connected to the electronic device through a network. Examples of the above network include, but are not limited to, the Internet, an intranet, a local area network, a mobile communication network, and combinations thereof.

The electronic device for implementing the playback control method may further include: an input device 603 and an output device 604. The processor 601, the memory 602, the input device 603, and the output device 604 may be connected through a bus or in other manners. In FIG. 6, the connection through the bus is taken as an example.

The input device 603 may receive inputted numeric or character information, and generate key signal inputs related to user settings and function control of an electronic device, such as a touch screen, a keypad, a mouse, a trackpad, a touchpad, an indication rod, one or more mouse buttons, trackballs, joysticks and other input devices. The output device 604 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other.

It should be understood that various forms of processes shown above may be used to reorder, add, or delete steps. For example, the steps described in the present disclosure may be performed in parallel, sequentially, or in different orders. As long as the desired results of the technical solutions disclosed in the present disclosure can be achieved, no limitation is made herein.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A playback control method, comprising:
obtaining a control instruction, wherein the control instruction comprises an identifier of a currently played video file, a current playback point, a control target, and a control type;
dividing the video file corresponding to the identifier to playback units according to the control target, and obtaining at least one playback unit related to the control target in the video file;
determining a playback unit to be controlled in the video file according to the control type and the at least one playback unit related to the control target; and
performing a control process on the playback unit to be controlled.

2. The method according to claim 1, further comprising:
obtaining voice information of a user before obtaining the control instruction;
identifying the voice information to obtain a voice recognition result; and
when the voice recognition result comprises the control target and the control type, generating the control instruction according to the voice recognition result, the identifier of the currently played video file, and the current playback point.

3. The method according to claim 1, wherein the control target comprises any one of a program, a first type of program, a program related to a first object, or a video clip.

4. The method according to claim 1, wherein dividing the video file corresponding to the identifier to playback units according to the control target, and obtaining the at least one playback unit related to the control target in the video file comprise:
extracting feature information related to the control target in frame contents of the video file;
determining relevance of adjacent frame contents in the video file according to the feature information related to the control target in the frame contents; and
dividing the video file into the playback units according to the relevance of the adjacent frame contents in the video file, and obtaining the at least one playback unit related to the control target in the video file.

5. The method according to claim 1, wherein the control type comprises any one of loop playback, skipping, playing the next, favoring, and sharing.

6. The method according to claim 1, wherein when the control type is loop playback, favoring or sharing, the playback unit to be controlled is a playback unit related to the control target and comprising the current playback point.

7. The method according to claim 1, wherein when the control type is playing the next, the playback unit to be controlled is the next playback unit of a playback unit related to the control target and comprising the current playback point.

8. A playback control apparatus, comprising a non-transitory computer-readable medium including computer-executable instructions stored thereon, and an instruction execution system which is configured by the instructions to implement at least one of:
an obtaining module, configured to obtain a control instruction, wherein the control instruction comprises an identifier of a currently played video file, a current playback point, a control target, and a control type;
a dividing module, configured to divide the video file corresponding to the identifier to playback units according to the control target, and obtain at least one playback unit related to the control target in the video file;
a determining module, configured to determine a playback unit to be controlled in the video file according to the control type and the at least one playback unit related to the control target; and
a processing module, configured to perform a control process on the playback unit to be controlled.

9. The apparatus according to claim 8, wherein the instruction execution system is further configured by the instructions to implement: an identifying module and a generating module;
the obtaining module is further configured to obtain voice information of a user;
the identifying module is configured to identify the voice information to obtain a voice recognition result; and
the generating module is configured to, when the voice recognition result comprises the control target and the control type, generate the control instruction according to the voice recognition result, the identifier of the currently played video file, and the current playback point.

10. The apparatus according to claim 8, wherein the control target comprises any one of a program, a first type of program, a program related to a first object, or a video clip.

11. The apparatus according to claim 8, wherein the dividing module is configured to:
extract feature information related to the control target in frame contents of the video file;
determine relevance of adjacent frame contents in the video file according to the feature information related to the control target in the frame contents; and
divide the video file into the playback units according to the relevance of the adjacent frame contents in the video file, and obtain the at least one playback unit related to the control target in the video file.

12. The apparatus according to claim 8, wherein the control type comprises any one of loop playback, skipping, playing the next, favoring, and sharing.

13. The apparatus according to claim 8, wherein when the control type is loop playback, favoring or sharing, the playback unit to be controlled is a playback unit related to the control target and comprising the current playback point.

14. The apparatus according to claim 8, wherein when the control type is playing the next, the playback unit to be controlled is the next playback unit of a playback unit related to the control target and comprising the current playback point.

15. A non-transitory computer-readable storage medium storing computer instructions, wherein the computer instructions are used to cause the computer to implement a playback control method, and the method comprises:
obtaining a control instruction, wherein the control instruction comprises an identifier of a currently played video file, a current playback point, a control target, and a control type;
dividing the video file corresponding to the identifier to playback units according to the control target, and obtaining at least one playback unit related to the control target in the video file;
determining a playback unit to be controlled in the video file according to the control type and the at least one playback unit related to the control target; and
performing a control process on the playback unit to be controlled.
